(19) United States
(12) Patent Application Publication
(10) Pub. No.: US 2025/0225670 A1
(43) Pub. Date: Jul. 10, 2025

(54) APPARATUS AND METHOD TO DETERMINE A SCALE OF AN OBJECT LOCATED IN A BACKGROUND IMAGE

(71) Applicant: CANON KABUSHIKI KAISHA, Tokyo (JP)

(72) Inventors: Floyd Albert Maseda, Tustin, CA (US); Quentin Florian Dietz, Irvine, CA (US); Xiwu Cao, Irvine, CA (US)

(21) Appl. No.: 19/009,744

(22) Filed: Jan. 3, 2025

Related U.S. Application Data
(60) Provisional application No. 63/618,077, filed on Jan. 5, 2024.

(51) Int. Cl. G06T 7/60; G06T 7/73

(52) U.S. Cl. CPC G06T 7/60; G06T 7/73; G06T 2207/20084; G06T 2207/30201

(57) ABSTRACT

An information processing apparatus is provided and includes one or more memories storing instructions; and one or more processors configured to execute the instructions stored in the memory to perform operations including receiving a captured image of a user at a first pose, extracting information of landmarks of the user in the captured image, obtaining information indicating a size of a user at a predetermined pose, based on the extracted information, determining a scale of an image of the user at the first pose based on the obtained information, and locating the determined scale of the image of the user at the first pose in a background image.

### CROSS-REFERENCE TO RELATED APPLICATIONS

This application claims the benefit of U.S. Provisional Patent Application Ser. No. 63/618,077 filed on Jan. 5, 2024 which is incorporated herein by reference in its entirety.

### BACKGROUND

### Technical Field

The present disclosure relates generally to video image processing in a virtual reality environment.

### Description of Related Art

Given the progress that has been recently made in mixed reality, it is becoming practical to use a headset or Head Mounted Display (HMD) to join a virtual conference or a get-together meeting and be able to see each other with 3D faces in real-time. The need for these gatherings has been made more important because, in some scenarios such as a pandemic or other disease outbreaks, people cannot meet together in person.

Headsets are needed so we are able to see the 3D faces of each other using virtual and/or mixed reality. However, with the headset positioned on the face of a user, no one can really see the entire 3D face of others because the upper part of the face will be blocked by the headset. Therefore, to find a way to remove the headset and recover the blocked upper face region from the 3D faces is critical to the overall performance in virtual and/or mixed reality.

An exemplary virtual reality immersive calling system is disclosed in WO2023/130046A1. In the virtual reality immersive calling system, a captured image of a first user wearing a head mount display (HMD) is captured and based on the captured image, an image of the first user without wearing any HMD is generated. The generated image is located in a virtual environment. The generated image and the virtual environment are displayed on a HMD worn by a second user. In these and other VR environments, the scale of the image of the user to be displayed needs to be determined so that the height of the user in the virtual environment matches the actual height of the user in the real world. One way to obtain a scale is for a user to input their height when they create a contact profile so that they may be properly scaled when rendered in the virtual environment.

### SUMMARY

According to the present disclosure, an image processing apparatus or a system is provided that determines a scale of an image of an object (for example, a human) in a virtual environment so that the height of the object in the virtual environment matches the actual height of the object in the real world.

To determine a scale of an image of an object (for example, a human) in a virtual environment so that the height of the object in the virtual environment matches the actual height of the object in the real world, the information processing apparatus explained in the embodiments below includes one or more memories storing instructions; and one or more processors configured to execute the instructions stored in the memory to perform operations including receiving a captured image of a user at a first pose, extracting information of landmarks of the user in the captured image, obtaining information indicating a size of a user at a predetermined pose, based on the extracted information, determining a scale of an image of the user at the first pose based on the obtained information, and locating the determined scale of the image of the user at the first pose in a background image.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a virtual reality capture and display system according the present disclosure.

FIG. 2 shows an embodiment of the present disclosure.

FIG. 3 shows a virtual reality environment as rendered to a user according to the present disclosure.

FIG. 4 illustrates a block diagram of an exemplary system according to the present disclosure.

FIG. 5 illustrates a 3D perception of a 2D human image in a 3D virtual environment according to the present disclosure.

FIGS. 6A & 6B illustrate HMD removal processing according to the present disclosure.

FIG. 7A is an exemplary image from a VR environment including the user presented in a first pose at an incorrect scale relative to the background image.

FIG. 7B is an exemplary image from a VR environment including the user presented in a first pose at a correct scale relative to the background image.

FIG. 7C is an exemplary image from a VR environment including the user presented in a first pose at an incorrect scale relative to the background image.

FIG. 7D is an exemplary image from a VR environment including the user presented in a first pose at a correct scale relative to the background image.

FIG. 8 is a flow diagram representing an algorithm for determining a correct scale of a user for a VR environment.

FIG. 9 is an illustrative view of the processing steps performed by the algorithm of FIG. 8.

FIG. 10 is a flow diagram representing an algorithm for determining a correct scale of a user for a VR environment.

FIG. 11 is an illustrative view of the processing steps performed by the algorithm of FIG. 8.

FIG. 12 is a flow diagram detailing a training process for training a machine learning model to infer a scale value used in scaling the user for insertion in to a VR environment.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

### Section 1: Environment Overview

The present disclosure as shown hereinafter describes systems and methods for implementing virtual reality-based immersive calling.

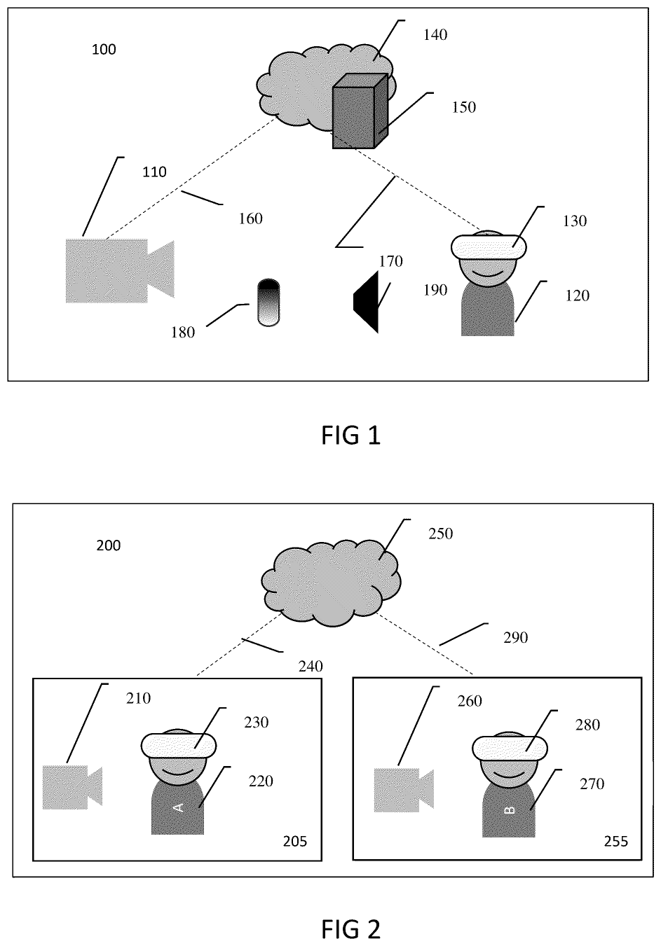

FIG. 1 shows a virtual reality capture and display system 100. The virtual reality capture system comprises a capture device 110. The capture device may be a camera with sensor and optics designed to capture 2D RGB images or video, for example. In one embodiment, the image capture device 110 is a smartphone that has front and rear facing cameras and which can display images captured thereby on a display screen thereof. Some embodiments use specialized optics that capture multiple images from disparate view-points such as a binocular view or a light-field camera. Some embodiments include one or more such cameras. In some embodiments the capture device may include a range sensor that effectively captures RGBD (Red, Green, Blue, Depth) images either directly or via the software/firmware fusion of multiple sensors such as an RGB sensor and a range sensor (e.g., a lidar system, or a point-cloud based depth sensor). The capture device may be connected via a network 160 to a local or remote (e.g., cloud based) system 150 and 140 respectively, hereafter referred to as the server 140. The capture device 110 is configured to communicate via the network connect 160 to the server 140 such that the capture device transmits a sequence of images (e.g., a video stream) to the server 140 for further processing.

Also, in FIG. 1, a user 120 of the system is shown. In the example embodiment the user 120 is wearing a Virtual Reality (VR) device 130 configured to transmit stereo video to the left and right eye of the user 120. As an example, the VR device may be a headset worn by the user. As used herein, the VR device and head mounted display (HMD) device may be used interchangeably. Other examples can include a stereoscopic display panel or any display device that would enable practice of the embodiments described in the present disclosure. The VR device is configured to receive incoming data from the server 140 via a second network 170. In some embodiments the network 170 may be the same physical network as network 160 although the data transmitted from the capture device 110 to the server 140 may be different than the data transmitted between the server 140 and the VR device 130. Some embodiments of the system do not include a VR device 130 as will be explained later. The system may also include a microphone 180 and a speaker/headphone device 190. In some embodiments the microphone and speaker device are part of the VR device 130.

FIG. 2 shows an embodiment of the system 200 with two users 220 and 270 in two respective user environments 205 and 255. In this example embodiment, each user 220 and 270 are equipped with a respective capture devices 210 and 260, respective VR devices 230 and 280, and are connected via respective networks 240 and 270 to a server 250. In some instances, only one user has a capture device 210 or 260, and the opposite user may only have a VR device. In this case, one user environment may be considered as a transmitter and the other user environment may be considered the receiver in terms of video capture. However, in embodiments with distinct transmitter and receiver roles, audio content may be transmitted and received by only the transmitter and receiver or by both, or even in reversed roles.

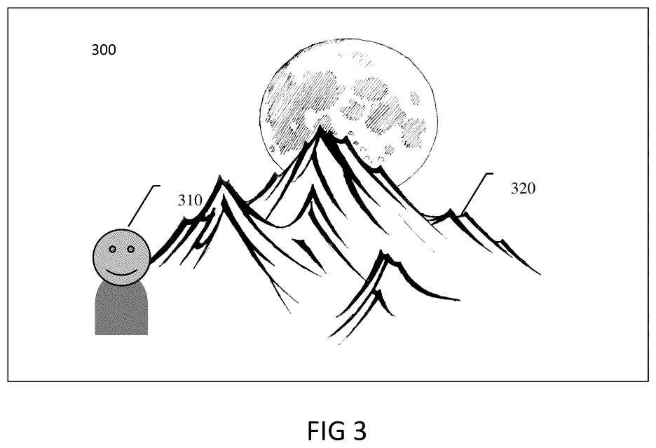

FIG. 3 shows a virtual reality environment 300 as rendered to a user. The environment includes a computer graphic model 320 of the virtual world with a computer graphic projection of a captured user 310. For example, the user 220 of FIG. 2, may see via the respective VR device 230, the virtual world 320 and a rendition 310 of the second user 270 of FIG. 2. In this example, the capture device 260 would capture images of user 270, process them on the server 250 and render them into the virtual reality environment 300.

In the example of FIG. 3, the user rendition 310 of user 270 of FIG. 2, shows the user without the respective VR device 280. The present disclosure sets forth a plurality of algorithms that, when executed, cause the display of user 270 to appear without the VR device 280 and as if they were captured naturally without wearing the VR device. Some embodiments show the user with the VR device 280. In other embodiments the user 270 does not use a wearable VR device 280. Furthermore, in some embodiments the captured images of user 270 capture a wearable VR device, but the processing of the user images remove the wearable VR device and replace it with the likeness of the users face.

Additionally, the addition of the user rendition 310 into the virtual reality environment 300 along with VR content 320 may include a lighting adjustment step to adjust the lighting of the captured and rendered user 310 to better match the VR content 320.

In the present disclosure, the first user 220 of FIG. 2, is shown via the respective VR device 230, the VR rendition 300 of FIG. 3. Thus, the first user 220, sees user 270 and the virtual environment content 320. Likewise, in some embodiments, the second user 270 of FIG. 2, will see in the same VR environment 320, but from a different view-point, e.g. the view-point of the virtual character rendition of 310 for example.

In order to achieve the immersive calling as described above, it is important to render each user within the VR environment as if they were not wearing the headset in which they are experiencing the VR content. The following describes the real-time processing performed that obtains images of a respective user in the real world while wearing a virtual reality device 130 also referred to hereinafter as the head mount display (HMD) device.

### Section 2: Hardware

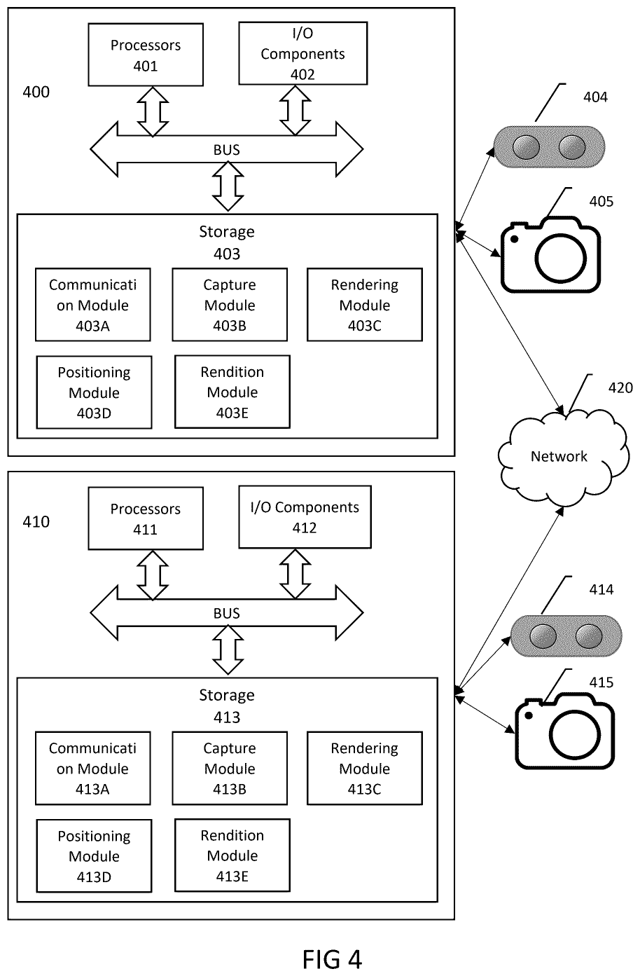

FIG. 4 illustrates an example embodiment of a system for virtual reality immersive calling system. The system includes two user environment systems 400 and 410, which are specially-configured computing devices; two respective virtual reality devices 404 and 414, and two respective image capture devices 405 and 415. In this embodiment, the two user environment systems 400 and 410 communicate via one or more networks 420, which may include a wired network, a wireless network, a LAN, a WAN, a MAN, and a PAN. Also, in some embodiments the devices communicate via other wired or wireless channels.

The two user environment systems 400 and 410 include one or more respective processors 401 and 411, one or more respective I/O components 402 and 412, and respective storage 403 and 413. Also, the hardware components of the two user environment systems 400 and 410 communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 401 and 411 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 402 and 412 include communication components (e.g., a graphics card, a network-interface controller) that communicate with the respective virtual reality devices 404 and 414, the respective capture devices 405 and 415, the network 420, and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storages 403 and $13 include one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storages 403 and 413, which may include both ROM and RAM, can store computer-readable data or computer-executable instructions.

The two user environment systems 400 and 410 also include respective communication modules 403A and 413A, respective capture modules 403B and 413B, respective rendering module 403C and 413C, respective positioning module 403D and 413D, and respective user rendition modules 403E and 413E. A module includes logic, computer-readable data, or computer-executable instructions. In the embodiment shown in FIG. 4, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage 403 and 413. Also, in some embodiments, the two user environment systems 400 and 410 includes additional or fewer modules, the modules are combined into fewer modules, or the modules are divided into more modules. One environment system may be similar to the other or may be different in terms of the inclusion or organization of the modules.

The respective capture modules 403B and 413B include operations programed to carry out image capture as shown in 110 of FIGS. 1, 210 and 260 of FIG. 2. The respective rendering module 403C and 413C contain operations programed to carry out the functionality associated with rendering images that are captured to one or more users participating in the VR environment. The respective positioning module 403D and 413D contain operations programmed to carry out the process including identifying and determining position of each respective user in the VR environment. The respective user rendition modules 403E and 413E contains operations programmed to carry out user rendering as illustrated in the following figures described hereinbelow. The prior-training module 403F contains operations programmed to estimate the nature and type of images that were captured prior to participating in the VR environment that are used for the head mount display removal processing. In some embodiments the some modules are stored and executed on an intermediate system such as a cloud server. In other embodiments, the capture devices 405 and 415, respectively, include one or more modules stored in memory thereof that, when executed perform certain of the operations described hereinbelow.

### Section 3: Overview of HMD Removal Processing

As noted above, in view of the progress made in augmented virtual reality, it is becoming more common to enter into an immersive communication session in a VR environment where each user is in their own location wearing a headset or Head Mounted Display (HMD) to join together in virtual reality. However, HMD device has blocked the capability of achieving better user experience if a HMD removal is not applied since you won't see the full face of others while in VR and others are unable to see your full face.

Accordingly, the present disclosure advantageously provides a system and method that remove the HMD device from a 2D face image of a user that is wearing the HMD and participating in a VR environment. Removing the HMD from a 2D image of a user's face and not from the 3D object is advantageous because humans can perceive 3D effect from a 2D human image by inserting the 2D image into 3D environment.

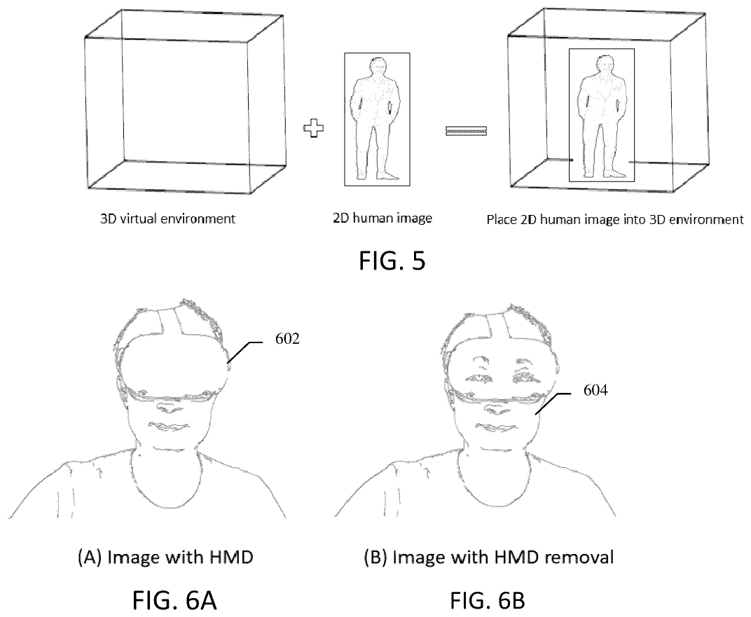

More specifically, in a 3D virtual environment, the 3D effect of a human being can be perceived if this human figure is created in 3D or is created with the depth information. However, the 3D effect of a human figure is also perceptible even if we don't have the depth information. One example is shown in FIG. 5. Here a captured 2D image of a human is placed into a 3D virtual environment. Despite not have the 3D depth information, the resulting 2D image is perceived as a 3D figure by human perception automatically filling the depth information. This is similar to the “filling-in” phenomenon for blind spots in human vision.

In augmented and/or virtual reality, users wear HMD device. At times, when entering a virtual reality environment or application, the user will be rendered as an avatar or facsimile of themselves in animated form but which does not represent an actual real-time captured image of themselves. The present disclosure remedies this deficiency by provide a real-time live view of a user in a physical space while they are experiencing a virtual environment. To allow the user to be captured and seen by others in the VR environment, an image capture device is camera positioned in front of the user to capture the user's images. However, because of the HMD device the user is wearing, others won't see the user's full face but only the lower part since the upper part is blocked by the HMD device.

To allow for full visibility of the face of the user being captured by the image capture device HMD removal processing is conducted to replace HMD region with an upper face portion of the image. An example is shown in FIG. 6 to illustrate the effect of HMD removal. We want to replace the HMD region 602 of the HMD image shown in FIG. 6A with one or more precaptured images of the user or artificially generated images to form a full face image 604 shown in FIG. 6B. In generating the full face image 604, the features of the face that are generally occluded when wearing the HMD 602 are obtained and used in generating the full face image 604 such that the eye region will be visible in the virtual reality environment. HMD removal is a critical component in any augmented or virtual reality environment because it improves visual perception HMD region 602 is replaced with some reasonable images of the user that were previously captured.

The precaptured images that are used as replacement images during the HMD removal processing are images obtained using an image capture device such as a mobile phone camera or other camera whereby a user is directed, via instructions displayed on a display device to position themselves in an image capture region and move their face in certain ways and make different facial expressions. These precaptured images may be still or video image data and stored in a storage device. The precaptured images may be cataloged and labeled by the precapture application and stored in a database in association with user specific credentials (e.g. a user ID) so that one or more of these precaptured images can be retrieved and used as replacement images to replace the upper face portion to replace an upper portion of the face image that contains the HMD. This process will be further described hereinafter.

In addition to generating an image of the user without the HMD occluding their face such that the generated image appears to another user in the VR environment as if the user was not wearing the HMD when the image of the user was being captured, it is important for the user's image to be properly scaled in the VR environment to provide other users in the VR environment with optimal image quality and size.

One way of determining the scale is to calculate a physical distance represented by a pixel in an image. For example, if the distance between a user's head and feet is determined to be 100 pixels in a given image, and the user is known to be 200 cm tall, each pixel represents 2 cm of physical distance. Then the entire image's height can be scaled in the VR environment according to this conversion factor. If the image is 500 pixels tall, it should be scaled to a size of 10 m so that the user who takes up only 100 rows of pixels appears their correct height of 200 cm. However, this method sometimes outputs improper scale. For example, when it is assumed that the distance between the top and bottom visible pixels of a foreground image corresponds to the user's height, this is not true if e.g. the user is raising their arms (top pixel is not their head) or crouching (distance is not their full height). Also, using shoulder-hip distance fails when e.g. the user is bowing towards the camera, in which case the pixel distance is smaller than the true 3D distance. Using a manually defined heuristic with only a few individual landmarks can suffer from the same type of issue.

The present disclosure is able to determine a scale of an image of an object (for example, a human) in a virtual environment so that the height of the object in the virtual environment matches the actual height of the object in the real world. In some embodiments, in addition to simply being able to view a video feed of each other, the two users are able to interact with other objects in the VR environment. In one exemplary embodiment, the users interact with one another and objects that are being generated by an application executing on an information processing apparatus such as in a scavenger hunt. In this embodiment, users compete to select some number of objects placed at predetermined, possibly randomized, locations in the common VR environment. Users may interact with the VR environment using one of a hand or controller tracking provided by the HMD. The users' video feeds are placed into the common environment in such a way that they appear to each other as they would in reality, i.e. scaled correctly and facing a consistent direction.

In an exemplary scavenger hunt environment, a virtual environment wherein multiple users, each equipped with a VR headset, engage in a head-to-head scavenger hunt. The scavenger hunt entails the identification and selection of virtual items strategically placed within the VR space. Upon locating a target item, a user may use VR controllers to interact with and select the item in real-time. Once an item is selected by one user, it becomes unavailable for selection by the opposing user. This ensures a competitive and dynamic gameplay experience. Both participating users are provided with a real-time video feed of their opponent. This shared video feed enhances the competitive nature of the scavenger hunt, allowing users to observe the movements and actions of their opponent. The video feed is seamlessly integrated into the VR experience, contributing to a heightened sense of presence and competition. The entire scavenger hunt experience is conducted within a virtual reality space, which is accessed through VR headsets worn by the users. The VR headset provides an immersive and visually stimulating environment, enhancing the overall user experience. Users are equipped with VR controllers that serve as the primary interface for interacting with the virtual environment. These controllers enable users to navigate the VR space, locate items, and make real-time selections. The responsive and intuitive nature of the VR controllers contributes to the dynamic and competitive aspects of the scavenger hunt.

In the scavenger hunt environment, as well as in the VR immersive calling application described hereinabove, it is important that users in the environment are properly scaled to the actual VR environment that is common to all users. In the scavenger hunt, a main goal is for one user to feel that the player they are competing against is present in their virtual world. To do that, the remote user is captured head to toe via their mobile phone camera opposite of the current user. The user scaling is very important here as the environments in which users find each other are real places that were 3D scanned, and having the remote user appear as their height in the real world helps maintain that immersive feeling. As both users compete to find items, the items are marked as being found or not for both users. This increases the feeling that the users are in a shared space.

There are several methods of determining the scale of the person, including (i) via an alpha channel obtained from a deep learning model trained to perform background segmentation, (ii) via a set of standard landmarks (e.g. of the shoulders, hips, hands, feet, etc.) obtained from a deep learning model trained to detect them, (iii) via a camera model configured to reflect the 3D scene detected by the camera and informed by some other device(s) such as the inertial measurement unit (IMU) of a head mounted device (HMD) or (iv) via a machine learning model described below using FIG. 8.

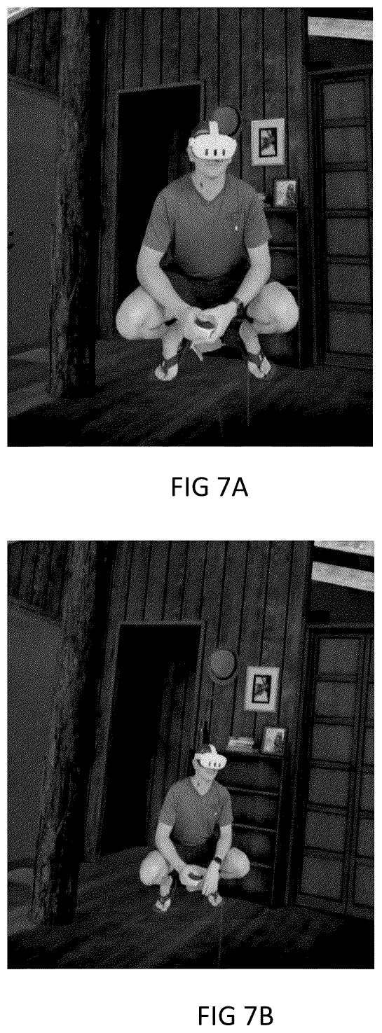

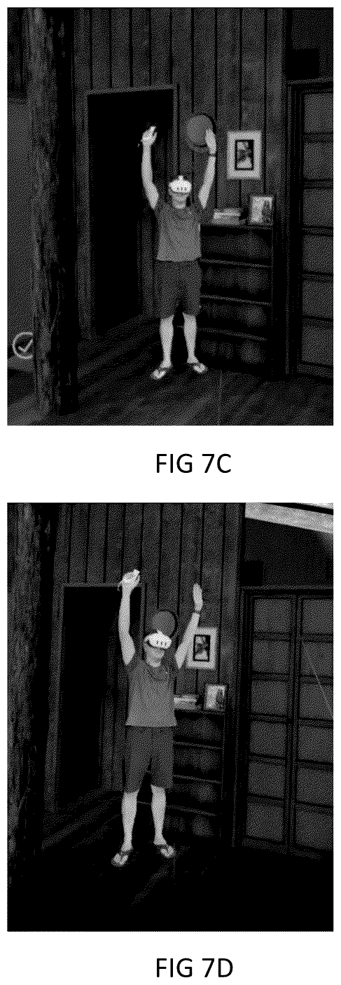

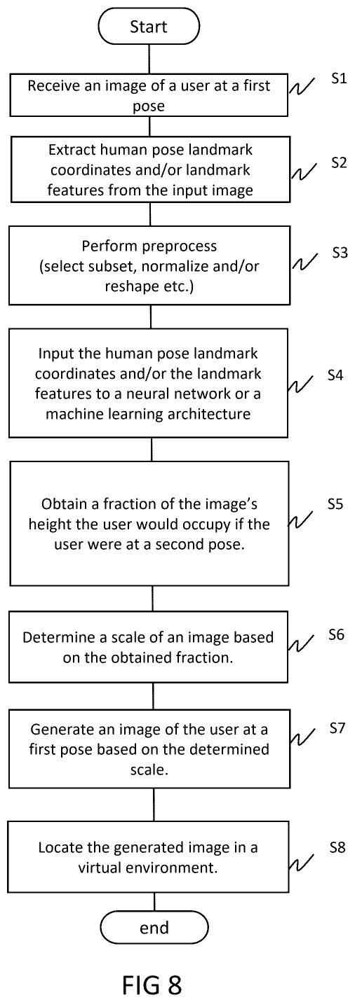

Though there are several ways of determining the distance between two or more landmarks in pixels, each has benefits and drawbacks which can cause them to give incorrect or undesired results in certain situations. FIGS. 7A & 7C illustrate exemplary user scaling output that fails reducing the immersive feeling when a user is projected into a VR environment.

Common to these methods (i) to (iii) is the determination of a conversion factor from pixels in the source image to meters or other physical units of measurement used to represent the image in the VR environment. In the alpha channel- and landmark-based methods, this conversion factor is obtained by determining the distance between two or more known landmarks in pixels, then using known physical measurements (for example, the user's height if the two landmarks are bottom of the feet and top of the head) as a reference. For example, if the distance between the user's head and feet is determined to be 100 pixels in a given image, and the user is known to be 200 cm tall, each pixel represents 2 cm of physical distance. Then the entire image's height can be scaled in the VR environment according to this conversion factor. If the image is 500 pixels tall, it should be scaled to a size of 10 m so that the user who takes up only 100 rows of pixels appears their correct height of 200 cm.

FIG. 7A depicts output from scaling processing performed on a user being captured, in real-time, via an image capture device such as a mobile phone. In this example, the scaling output generates an image of the user having the wrong height. In FIG. 7A, the user is crouching. However, when compared to the scale of the door frame in the VR environment, the user appears much bigger than their actual height in the virtual space. This results from an incorrect assumption made in the scaling algorithm whereby the distance between the top and bottom visible pixels of an image of the user corresponds to a full height of the user standing. But this assumption is erroneous because the user is crouching and the distance is not their actual full height of the standing user. Using this assumption, the scaled output is an image of the crouching user displayed with the user's full height of the standing user in the virtual space when the full height of the standing user is previously stored in the system in advance.

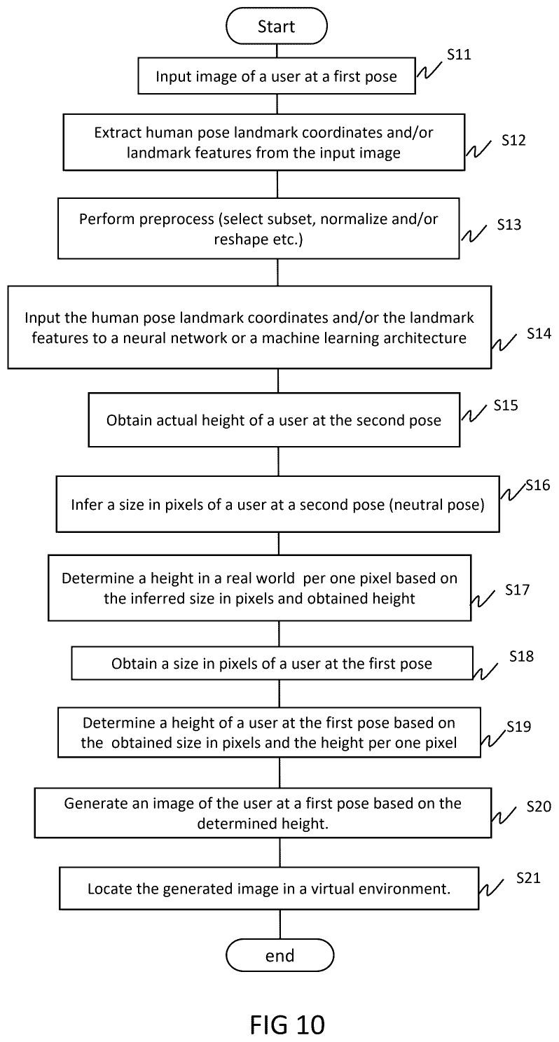

FIG. 7B illustrates an improved scaling output generated according the algorithm in the present disclosure which includes a machine learning based approach explained below using either FIG. 8 or FIG. 10. According to the scaling algorithm of the present disclosure, an image of a user is correctly scaled the user's height appears to match the user's actual height as shown in FIG. 7B. As can be seen in FIG. 7B the height of the user appears correct relative to the background door frame in the VR environment and, compared to FIG. 7A, which makes the crouching user appear nearly as tall as the door frame, the scale of the user in FIG. 7B provides a more immersive, natural depiction of the user in VR.

Turning now to FIG. 7C, when a user raises their hands, the user appears much smaller than their actual height in the virtual space with the alpha scaling method. This results from the incorrect assumption that the distance between the top and bottom of visible pixels of an image of the user corresponds to a full height of the user without raising their hands, while the user raises their hands. The distance from the tip of the raised hand to the toe is not their actual full height. Then the image of the user raising hands is displayed, in the virtual space, as if that user was standing at their full height without raising hands which is stored in the system in advance.

FIG. 7D, similarly to the output shown in FIG. 7B uses the scaling algorithm according to the present disclosure which is a machine learning based method explained below using FIG. 8 or FIG. 10 which results in the user being displayed in the VR environment with their hands above their head in the proper scale such that the user maintains a natural height relative to the background image which is the VR environment generated by a VR application.

### Determination of a Scale of a Person Utilizing a Machine Learning Algorithm

Turning to FIG. 8 which illustrates an algorithm (e.g. set of computer executable instructions) that is stored in one or more memories and that, when executed configure one or more processors of an apparatus to perform the functions and processing described herein. As illustrated in FIG. 8, a method which relies on a machine learning algorithm to ingest landmarks obtained from an image of a person and produce a scale factor rather than relying on a hand-tailored algorithm is provided. This method uses three core processing operations. A first core processing operation includes the identification of and extract of human pose landmark coordinates and/or landmark features from an input image, point cloud, or other input such as information obtained from a preconfigured library such Mediapipe pose landmarks. A second core processing operation includes using a neural network or other machine learning architecture which accepts landmark coordinates and/or landmark features (e.g. visibility/confidence of each landmark) from the first cire processing operation and produces a single output interpreted as height information representing a fraction of the image's height the user would occupy if they were standing straight up facing the camera in a neutral pose with arms by their side, legs straight. The third core processing operation includes execution of a training loop which uses some images or video with known ground truth for each frame, which we then artificially augment with various scales, translations, or other transformations to improve robustness.

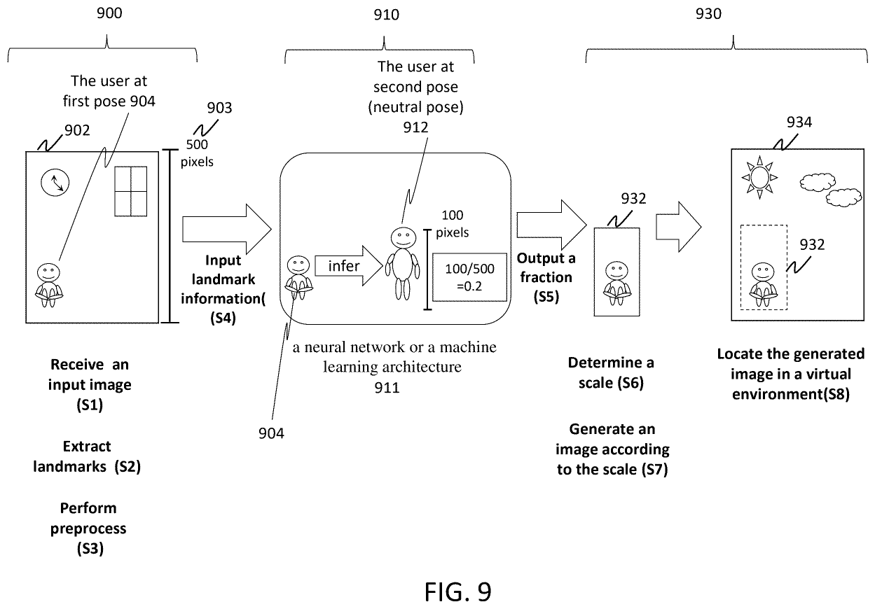

An exemplary algorithm comprising the workflow of determining a scale of a human image in a virtual world is explained using FIG. 8 and FIG. 9. The steps in FIG. 8 are performed by one or more processors by executing one or more programs in one or more memories. The processor may be in a server 250 (FIG. 4) that determines the scale of a human image in a virtual space.

In one embodiments, in step S1, a captured image of a user at a first pose (for example, crouching or raising their hands) is received by the server 250 and is input to a neural network or a machine learning architecture. In one embodiment, the captured image to be used as input is captured by an application executing on an image capture device (e.g. mobile phone) that captures live images, in real time, of the user wearing a HMD. In this embodiment, the user is moving or otherwise enters into various poses based on visual interaction with a VR environment that the user is viewing and reacting to being displayed on a display of the HMD.

In step S2, human pose landmark coordinates and/or landmark features from the input image is extracted. The pose landmark extraction tool may output xy-coordinates in image space for each landmark. Other outputs by the tool may include an inferred or otherwise calculated z coordinate. Other outputs may include additional features such as the visibility, confidence, or other information for each landmark. Some embodiments may have as input a 3D point cloud that may or may not have been extracted from a 2D input image. The landmarks that will be fed to the machine learning model may then be inferred from the point cloud directly or from the originating 2D image, if present. In certain embodiments, the landmarks used for inference processing are holistically determined based on a number of different landmarks identified and extracted including, shoulder, neck, hands, feet and legs. As such, just because a detected distance between two landmarks is a certain distance does not mean that those landmarks are true indicators of height of the user. For example, in the case where a user is crouching in FIGS. 7A and 7B, landmarks indicative of a shoulder and hip may be close together causing the height to be improperly determined. The machine learning model described hereinbelow is trained to properly ingest and understand a correct height using relative positions of all of the extracted landmarks.

In step S3, the one or more processors perform preprocessing. The preprocessing operations includes at least one of a selection of a subset, normalizing or reshaping. For example, the subset may be the shoulders, elbows, hands, hips, knees, and feet landmarks. In this embodiment, landmarks associated with the face are not used because a face of a user in the input image is hidden by a HMD.

Some landmark extraction tools normalize landmarks to [0,1] in image space, but other landmark extraction tools may give unnormalized landmarks e.g. pixel values, which may be different for images of different sizes. Typically machine learning models do better when their input is consistently of the same scale, e.g. all in [0,1]. Then output of the landmark extraction tool is normalized.

For reshaping, an input vector with x, y, z, visibility is formed for each of for example 12 landmarks, so a length 48 vector to be input to the machine learning model. Other embodiments may order the landmarks differently, not include the same set of features, etc., so may reshape the information differently.

The operations of steps S1-S3 are depicted in a first section 900 of FIG. 9 which illustrates an exemplary image 902 of a user 904 captured by the image capture device and used as the input image. The captured image 902 is of the user 904 in real space and includes the user in real space wearing an HMD device. The captured image 902 of the user in real space has a determined image height 903 represented here in a number of pixels. In the example shown here, the determined image height is 500 pixels. However, this should not be seen as limiting and the image height is directly correlated with the image capture process performed by the image capture device. Further, as shown herein the user 904 is shown positioned in a first pose and the landmarks that are identified and extracted in step S2, are done using the position of the user in real space in the first pose 904 and one or more preprocessing operations are performed to provide additional information regarding the landmark information extracted to the next processing stage.

Turning back to FIG. 8, in step S4, the human pose landmark coordinates and/or the landmark features extracted and preprocessed in S2 and S3, are input to a neural network or a machine learning architecture. The machine learning architecture may consist of a simple feedforward fully connected neural network with only one or a few hidden layers while in others, more sophisticated architectures may be implemented. Common to all architectures is the ability to ingest some or all of the landmark coordinates and/or feature information and output a single number (S5). In this embodiment, the number is interpreted as the fraction of the image's height the user would occupy if they were standing straight up facing the camera in a neutral pose with arms by their side, legs straight (a second pose/a predetermined pose). This number is obtained for each of image frame. Some embodiments may clamp this output to [0,1] or some other interval so that the user may never appear larger or smaller than a given scale factor, e.g. the height of the entire image. Others may allow an unbounded or partially bounded output; for example, the output may be bounded below by zero and be unbounded above, e.g. with a ReLU activation function.

The processing described in steps S5 and S6 are illustrated in the second section 910 of FIG. 9 which illustrates a neural network or machine learning model 911 trained to infer an output number representing the fraction of the image's height the user would occupy using the landmark information input from step S4 of the user in the first pose relative to the user being in a second pose 912 representing a neutral pose (e.g. standing straight, arms and legs at their side). In the inference processing performed that results in the output of the single number in step S5, the height and position of the landmarks relative to the height of the input image 902 are used and compared with the height in pixels of the user in the neutral pose.

In S6, the one or more processors determines a scale value for determining the scale that the user will be presented in the generated image in the VR environment such as shown in FIGS. 7B & 7D. In determining the scale value, the obtained fraction inferred from step S5 is used such that a known height of the user in real-space is divided by the obtained fraction to obtain the scale value. The known height of the user may be stored in a user profile. In step S7, the one or more processors generates an image of the user at a first pose based on the determined scale. Then, in step S8, the one or more processors position or otherwise locate the generated image in a virtual environment whereby the VR environment represents a background image and the generated image is inserted into or overlaid on top of the image in the VR environment such that the composite image is viewable by the user and other users that are concurrently experiencing the VR environment at a same time. The processing operations in steps S6-S8 are illustrated in the third section 930 which depicts the first user in the first pose properly scaled in a generated image 932 which is then positioned into the VR environment image 934. Once completed, the result is the user being depicted in the appropriate position with the appropriate scale relative to the background image of the VR environment as is illustrated in FIGS. 7B & 7D.

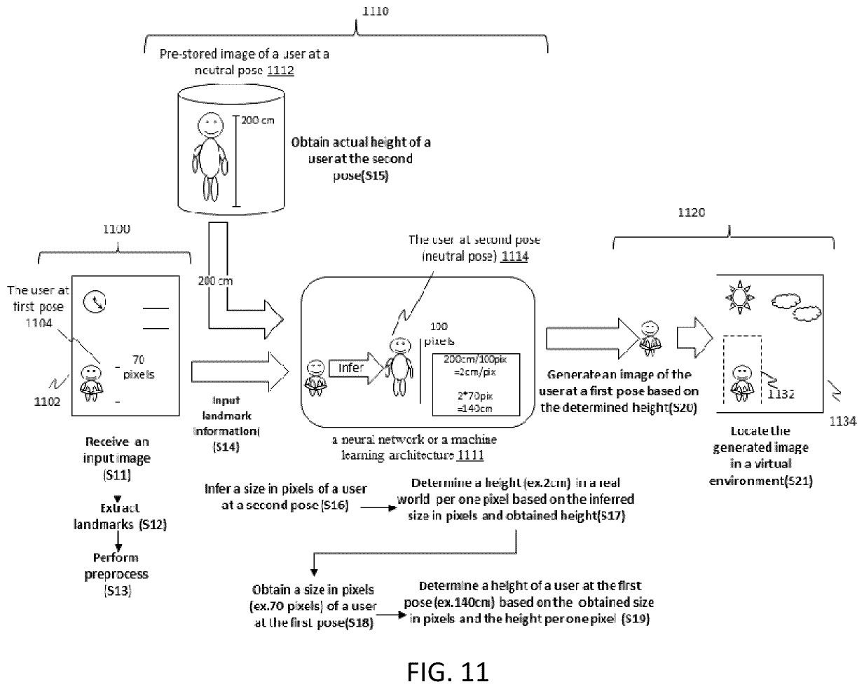

In another embodiment, the machine learning model can be conceivably trained with a different output, e.g. the scale factor directly. In this embodiment, a known value of the user height is input to the network along with the extracted landmarks. Workflow of determining a scale of a human image in a virtual world is explained using FIG. 10 and FIG. 11. For example, the steps in FIG. 10 are performed by one or more processors by executing one or more programs in one or more memories. The processor may in a server 250 that determines the scale of a human image in a virtual space.

The processing operations includes steps S11-S14 which directly correlate to steps S1-S4 described in FIG. 8. As such, the description of those steps need not be repeated and is incorporated herein by reference. Furthermore, turning to FIG. 11, the first section 1100 in FIG. 11 include visual depictions of the processing steps S11-S13 which are also described in the first section 900 of FIG. 9. In summary, the captured image 1102 includes an image of the user 1104 in the first pose as captured in real space and a size of the first user in the first pose is determined in pixels. As shown herein, the actual size of the first user in the first pose is 70 pixels.

In step S15, an actual height of a user at the second pose (e.g. the neutral pose) is obtained by the one or more processors from a memory. In one example actual height information may be entered by a user when creating a user profile and stored in association therewith. In the example shown herein the actual height actual height of the user is 200 cm. In step S16, a size in pixels of a user at a second pose (neutral pose) is inferred by the neural network or the machine learning architecture. In step S17, the one or more processors determine a height in a real world per one pixel based on the inferred size in pixels and obtained height. In step S18, the one or more processors obtain a size in pixels of a user at the first pose and in step S19, the one or more processors determine a height of a user at the first pose.

The processing operations corresponding to steps S15-S19 are illustrated in the second section 1110 of FIG. 11. Landmark information derived in step S14 is provided as an input to the machine learning model/neural network 1111. In the example of FIG. 11, the inferred size 1114 of the user in the second neutral pose performed by the machine learning network/neural network is 100 pixels. Also the actual height information 1112 that has been prestored in memory is obtained and provided as additional input to the machine learning model/neural network 1111. As illustrated herein, the actual height information 1112 of the user in the second neutral pose is 200 cm. Based on this, the model determines the height per pixel value by dividing the actual height information 1112 and the determination of the height per pixel is computed as 2 cm (200 cm/100 pixels). The height per pixel is applied to the height of the user in pixels to determine the proper scale value for the user which, as shown herein is 140 cm (2 cm per pixel*70 pixels of user height in image) which yields the height of the user for purposes of the VR environment.

Turning back to FIG. 10, in step S20, the one or more processors generate an image of the user at a first pose 1102 based on the determined height so that the image of the crouching user corresponds to 140 cm in the virtual environment and in step S21, the one or more processors locate the generated image in a virtual environment. These steps are illustrated in the third section 1120 of FIG. 11 which depicts the first user in the first pose 1102 properly scaled in a generated image 1132 which is then positioned into the VR environment image 1134. Once completed, the result is the user being depicted in the appropriate position with the appropriate scale relative to the background image of the VR environment as is illustrated in FIGS. 7B & 7D.

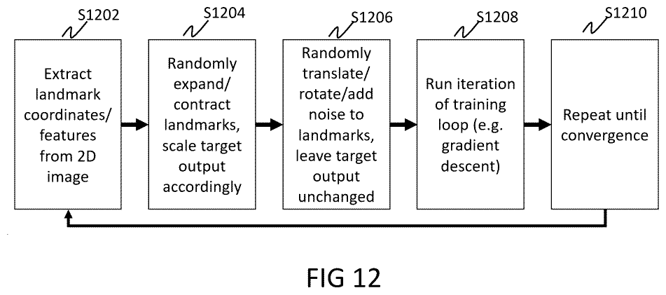

FIG. 12 is a flowchart illustrating the training processing performed to generate the trained model that is used to perform the inference processing described above. To train the machine learning model a set of images or video frames with known ground truth outputs are used. Some embodiments will use a video or multiple videos where the user remains a fixed distance from the camera (and thus ideally should remain a constant scale) and performs various actions, e.g. raising hands, crouching, bowing, etc. Every frame of this video can then be labelled with the same output scale, determined from some other scaling method, e.g. using the alpha channel or hand-tailored algorithms such as the shoulder-hip distance. To prevent the network from simply outputting this constant for all frames regardless of actual scale, the training loop should implement augmentation of the input data. In step S1202, for each image used to train the model, landmarks coordinates are extracted from each 2D image. In step S1204, extracted landmarks are randomly shrunk or expanded in each input image about their center of mass or some fixed point in the image, e.g. its center. This augmentation requires the output scale to be modified by a corresponding amount, which in turn trains the network to output varying values instead of the single constant label. In step 1206, additional augmentations are performed and include translations in image space so that the network may robustly determine scale independent of the location of the person in the image, rotations of the landmarks in the image, random perturbations in the landmark coordinates and/or features, etc. In step 1208, iteration processing is performed such as a gradient descent which is then, in step S1210, repeated until convergence occurs thereby yielding a trained model that can properly infer a height of the user based on the extracted landmarks in the image as described above.

According to the embodiments explained using FIG. 8 to FIG. 12, an image processing apparatus and method is provided in an apparatus or a system and determines a scale of an image of an object (for example, a human) in a virtual environment so that the height of the object in the virtual environment matches the actual height of the object in the real world and the system can display an image of a user in the virtual environment with proper size, even if the user is not at a neutral pose in front of the camera.

In certain embodiments, the information processing method includes receiving a captured image of a user at a first pose, extracting information of landmarks of the user in the captured image, obtaining information indicating a size of a user at a predetermined pose, based on the extracted information, determining a scale of an image of the user at the first pose, based on the obtained information, and locating the determined scale of the image of the user at the first pose in a background image.

In one embodiment, the information indicating the size of the user at the predetermined pose is outputted by a neural network or the machine learning architecture. In other embodiments, the neural network or the machine learning architecture is trained with one or more images including an image of the user at a different pose from the predetermined pose.

In another embodiment, the information indicating the size of the user at a predetermined pose is a fraction of the image's height the user would occupy if the user were at the predetermined pose and/or the predetermined pose of the user is a standing pose straight up facing the camera in a neutral pose with arms by their side and legs straight.

In other embodiment, the method and apparatus includes extracting information of the landmarks without landmark information of a face and/or inferring a size of the user at the predetermined pose based on the information of landmarks of the user at the first pose, and obtaining the information indicating the size of the user at the predetermined pose, based on the inferred size. In a further embodiment, pre-stored information of a height of a user at the predetermined pose is used to determine the scale.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

We claim:

1. An information processing apparatus comprising:
one or more memories storing instructions; and
one or more processors configured to execute the instructions stored in the memory to perform operations including:
receiving a captured image of a user at a first pose,
extracting information of landmarks of the user in the captured image,
obtaining information indicating a size of a user at a predetermined pose, based on the extracted information,
determining a scale of an image of the user at the first pose based on the obtained information, and
locating the determined scale of the image of the user at the first pose in a background image.

2. The information processing apparatus according to claim 1, wherein the information indicating the size of the user at the predetermined pose is outputted by a neural network or the machine learning architecture.

3. The information processing apparatus according to claim 2, wherein the neural network or the machine learning architecture is trained with one or more images including an image of the user at a different pose from the predetermined pose.

4. The information processing apparatus according to claim 1, wherein the information indicating the size of the user at a predetermined pose is a fraction of the image's height the user would occupy if the user were at the predetermined pose.

5. The information processing apparatus according to claim 1, wherein the predetermined pose of the user is a standing pose straight up facing the camera in a neutral pose with arms by their side and legs straight.

6. The information processing apparatus according to claim 1, wherein the one or more processors execute the instructions to perform:
extracting information of the landmarks without landmark information of a face.

7. The information processing apparatus according to claim 1, wherein the one or more processors execute the instructions to perform:
inferring a size of the user at the predetermined pose based on the information of landmarks of the user at the first pose, and
obtaining the information indicating the size of the user at the predetermined pose, based on the inferred size.

8. The information processing apparatus according to claim 1, wherein a pre-stored information of a height of a user at the predetermined pose is used to determine the scale.

9. An information processing method comprising:
receiving a captured image of a user at a first pose,
extracting information of landmarks of the user in the captured image,
obtaining information indicating a size of a user at a predetermined pose, based on the extracted information,
determining a scale of an image of the user at the first pose, based on the obtained information, and
locating the determined scale of the image of the user at the first pose in a background image.

10. The method according to claim 9, wherein the information indicating the size of the user at the predetermined pose is outputted by a neural network or the machine learning architecture.

11. The method according to claim 10, wherein the neural network or the machine learning architecture is trained with one or more images including an image of the user at a different pose from the predetermined pose.

12. The method according to claim 9, wherein the information indicating the size of the user at a predetermined pose is a fraction of the image's height the user would occupy if the user were at the predetermined pose.

13. The method according to claim 9, wherein the predetermined pose of the user is a standing pose straight up facing the camera in a neutral pose with arms by their side and legs straight.

14. The method according to claim 9, further comprising:
extracting information of the landmarks without landmark information of a face.

15. The information processing apparatus according to claim 9, further comprising:
inferring a size of the user at the predetermined pose based on the information of landmarks of the user at the first pose, and
obtaining the information indicating the size of the user at the predetermined pose, based on the inferred size.

16. The method according to claim 9, wherein a pre-stored information of a height of a user at the predetermined pose is used to determine the scale.

17. A non-transitory computer readable storage medium storing instructions that when executed by one or more processors cause the one or more processors to perform operations including:
receiving a captured image of a user at a first pose,
extracting information of landmarks of the user in the captured image,
obtaining information indicating a size of a user at a predetermined pose, based on the extracted information,
determining a scale of an image of the user at the first pose, based on the obtained information, and
locating the determined scale of the image of the user at the first pose in a background image.
